(19) United States
(12) Patent Application Publication
(10) Pub. No.: US 2024/0017733 A1
(43) Pub. Date: Jan. 18, 2024

(54) METHOD FOR DETERMINATION OF STATE INFORMATION, ESPECIALLY DESCRIBING A TRIBO-LOGICAL STATE OF A DRIVE TRAIN, AND MOTOR VEHICLE

(71) Applicant: AUDI AG, Ingolstadt (DE)

(72) Inventor: Franz HONKOMP, Ingolstadt (DE)

(21) Appl. No.: 18/351,398

(22) Filed: Jul. 12, 2023

(30) Foreign Application Priority Data
Jul. 13, 2022 (DE) 102022117410.7

(51) Int. Cl. B60W 50/04; B60W 20/50; B60W 50/14

(52) U.S. Cl. CPC B60W 50/045; B60W 20/50; B60W 50/14; B60W 2510/081; B60W 2510/24

(57) ABSTRACT

A method for determination of state information, especially describing a tribological state of a drive train of a motor vehicle, wherein the drive train comprises an electric machine as a first drive machine and a second drive machine, wherein upon fulfillment of a diagnostic condition the first drive machine is operated in an electrical idling mode, in which it is electrically separated from all current sources and current sinks and coupled to at least one of the wheels of the motor vehicle, and during the operation of the first drive machine in the electrical idling mode a performance measure is acquired for the performance of the second drive machine, while at least one of the wheels of the motor vehicle is driven by the second drive machine, after which the state information is determined in dependence on the performance measure and given reference information.

### BACKGROUND

### Technical Field

The disclosure relates to a method for determination of state information, especially describing a tribological state of a drive train of a motor vehicle, wherein the drive train comprises an electric machine as a first drive machine and a second drive machine. In addition, the disclosure relates to a motor vehicle.

### Description of the Related Art

In motor vehicles, the wear on components of the drive train, such as wheel bearings, drive shafts, differentials, gearboxes, and drive machines, especially when this wear is detected late, can result in excessive consumption of the motor vehicle, high repair costs, and sometimes even breakdown of the motor vehicle. These disadvantages for vehicle users can also result in reputational injury for the manufacturers, even when such problems result from inadequate vehicle maintenance by the users.

It is therefore advisable to monitor the wear on such components, in order to recommend a servicing of the motor vehicle to the user in good time and in particular in preventive manner. One possible approach for this is set forth in publication US 2017/0 221 069 A1. This publication teaches how to detect a fuel consumption for different numbers of revolutions and torques of a drive machine and how to estimate on the basis of this fuel consumption the dissipation in the drive train.

However, if an electric machine is used in the drive train, a mere consumption monitoring cannot distinguish between electrical losses and mechanical losses, so that mechanical wear cannot be clearly identified. This is particularly problematical, since electrical losses are heavily dependent on the performance currently provided by the electric machine. Furthermore, losses in an electrically powered drive train are partly dependent by hysteresis on various factors of influence, such as the outdoor temperature or the temperature of the oil in a cooling circuit, and temperatures in the cooling circuit may also depend on the current or immediately preceding performance of the electric machine, for example, so that the identification of wear in this case might be inexact and erroneous.

### BRIEF SUMMARY

Thus, embodiments of the disclosure provide a way of determining a state, especially a tribological state or a state of wear, of a drive train having an electric machine with greater accuracy and robustness.

Embodiments of the disclosure provide a method of the kind mentioned above, wherein upon fulfillment of a diagnostic condition the first drive machine is operated in an electrical idling, in which it is electrically separated from all current sources and current sinks and coupled to at least one of the wheels of the motor vehicle, and during the operation of the first drive machine in the electrical idling a performance measure is acquired for the performance of the second drive machine, while at least one of the wheels of the motor vehicle is driven by the second drive machine, after which the state information is determined in dependence on the performance measure and given reference information.

Thanks to the method according to the disclosure, in which the first drive machine remains coupled, in the course of acquiring the performance measure or the state information, to at least one wheel, i.e., to the wheels of one axle driven by the first drive machine, for example, or to all the wheels, but is operated in electrical idling, mechanical losses in the first drive machine and thus in particular its tribological state can be taken into account when acquiring the performance measure or the state information, but the measurement at the same time is not affected by electrical losses at the first drive machine. Hence, the aforementioned dependence of the performance measure or the acquired state information on a current or immediately preceding performance indication by the first drive machine is eliminated. Furthermore, the measurement is not affected by age effects of electric components of the first drive machine. Thus, the accuracy and the robustness of the determination of the state of the drive train can be significantly improved as compared to the prior art, especially when this is supposed to be done on the basis of a single performance acquisition or a few performance acquisitions. In particular, it is possible to better distinguish between a change in the tribological state of the drive train and the state of the power electronics.

The tribological state can be understood as being a state of friction or wear of the drive train, i.e., the drive machine and the components which transfer their torques to at least one of the wheels of the motor vehicle. A change in the tribological state can result for example from wear and especially a resulting increased friction or from deficient lubrication of at least some parts of the drive train. An impairment of the tribological state thus leads to higher friction losses in the drive train, so that a higher performance of the second drive machine may be needed to maintain a given speed of the motor vehicle during straight-line travel than would be the case with an unimpaired tribological state. Therefore, the diagnostic condition can be fulfilled for example during straight-line travel of the motor vehicle at constant speed, where the performance measure will relate in particular to the required performance of the second drive machine needed to maintain this constant speed.

The performance measure can describe directly the performance, especially a nondimensional quantity, or it can have an unambiguous and known correlation with the performance of the second drive machine.

The first and second drive machine can drive the same wheel or the same wheels. For example, both drive machines can be coupled to the same drive shaft, which is coupled for example across a differential to the driven wheels. Alternatively, however, the drive machines can also drive different wheels. For example, the first drive machine can be coupled to the wheels of the front axle and the second drive machine to the wheels of the rear axle, or vice versa. The method according to the disclosure can also be used when a separate drive machine is used for each of the wheels. Then, upon fulfillment of the diagnostic condition, the motor vehicle can be driven for example by the drive machines of the front wheels and the drive machines of the rear wheels can be operated as the first drive machine in the electrical idling or vice versa.

The fulfillment of the diagnostic condition may depend on a prior operator input by the vehicle user. For example, the diagnostic condition can only be fulfilled if a diagnostic operation has been enabled through an operator means of the motor vehicle or an external device. This can serve, for example, to carry out the method according to the disclosure only when the user of the vehicle so desires, for example, in the course of a test drive, which can be carried out for example by a repair shop in the course of a servicing of the vehicle.

The second drive machine can be, e.g., an electric machine or an internal combustion engine.

If an electric machine is also used as the second drive machine, then a current supplied to the second drive machine, especially a direct current, can be detected by a current sensor of the motor vehicle and a voltage dropping across the second drive machine, especially a DC voltage, can be detected by a voltage sensor of the motor vehicle, wherein the performance measure is acquired as the product of the detected current and the detected voltage or in dependence on this product. In particular, the product can be averaged or integrated over a given time interval. With this procedure, the performance measure can be acquired with good accuracy and slight technical expense.

A detection of a direct current or a DC voltage can be done in particular prior to an inverting by a power inverter of the second drive machine. In this case, only a single current and voltage sensor is required and the calculation of the performance measure is especially easy. Alternatively, it would be possible for example to detect currents and voltages for the different phases of the second drive machine, for example after a current transformation by a power inverter, and to use this for acquiring the performance measure. For example, separate performances can be acquired for the individual phases and these can be added up to form the performance measure.

If an electric machine is also used as the second drive machine, after acquiring the performance measure once again the diagnostic condition or a further diagnostic condition can be checked and if the diagnostic condition is again fulfilled or if the further diagnostic condition is fulfilled then the second drive machine is operated in an electrical idling, in which it is electrically separated from all current sources and current sinks and coupled to at least one of the wheels of the motor vehicle, and during the operation of the second drive machine in the electrical idling a further performance measure can be acquired for the performance of the first drive machine, while at least one of the wheels of the motor vehicle is driven by the first drive machine, after which the state information can be determined in dependence on the performance measure and the further performance measure.

The state information can thus depend on the performance measure, the further performance measure and the reference information or a respective reference information for the respective measurement at the respective drive machine. The measurement of separate performance measures for the two drive machines allows one to distinguish in particular between an actual increase in the towing capacity due to a change in the tribological state of the drive train and a change in the state of electric components of one of the drive machines.

For example, if the efficiency of the second drive machine decreases because of a suboptimally functioning inverter and/or because of current leakage or the like, this will only change the performance measure, while the further performance measure remains unchanged, since the second drive machine is operated in electrical idling during this acquisition, so that any influence of the electric components of the second drive machine on the measurement is avoided. Conversely, an efficiency loss of the first drive machine due to the state of its electric components results only in a change in the further performance measure, while the performance measure remains unchanged.

By contrast, however, any change in the tribological state of the drive train, regardless of whether this change occurs in the first or the second drive machine or in one of the further components of the drive train, will result in larger friction losses in the drive train and thus in both a change in the performance measure and a change in the further performance measure, for example, when these are acquired while the particular drive machine used for the driving is supposed to maintain the speed of the motor vehicle constant.

Thus, thanks to the described method, it can be determined, for example in the course of a test drive, whether the tribological state of the drive train is affected or whether the electric components of the first or second drive machine are resulting in suboptimal efficiency.

The reference information can be given in dependence on a speed of the motor vehicle and/or a number of revolutions of the first and/or the second drive machine. The reference information can involve, in particular, the performance or the performance measure which would be expected from an optimal state or an optimal tribological state of the drive train.

An impairment of the state of the drive train can thus be quantified, for example, by a difference between a performance measure and reference information or by a quotient of these quantities. It is especially expedient to consider the number of revolutions of the first or second drive machine when a single-speed gearbox is used between the respective drive machine and the driven wheels. Alternatively, information about the gear speed engaged can be considered in addition when dictating the reference information.

Numbers of revolutions of drive machines may be directly available based on control information for the corresponding drive machine or they are often acquired in any case, for example for a field-oriented regulation or vector regulation of the particular drive machine. Alternatively or for validation, the speed of the motor vehicle can also be taken into account, which can be acquired for example on the basis of the wheel number of revolutions or for example a satellite-supported position acquisition. Dictating of the reference information based on the mentioned quantities or at least one of these quantities can be done for example with the aid of a look-up table or by dictating an analytical relationship. An analytical relationship can be determined for example with the aid of a regression analysis based on measurements of the drive train in its factory-new condition.

The diagnostic condition can only be fulfilled when the speed or a speed of the motor vehicle and/or the number or a number of revolutions of the first and/or the second drive machine is constant across a given time interval or lies within a range of variation with given breadth, wherein a measure of the performance of the second drive machine, which will be applied in order to maintain the speed and/or the number of revolutions constant or in the variation interval while the first drive machine is operated in electrical idling, will be acquired as the performance measure. The use of a variation interval can be expedient, since regardless of whether a speed regulation is done automatically or whether a vehicle passenger tries to maintain an essentially constant speed, certain speed deviations and thus variations in the number of revolutions may occur. For example, the breadth of the variation interval can be chosen such that it corresponds to 5% or 10% of the current speed or number of revolutions.

Accordingly, a measure of the performance of the first drive machine, which will be applied in order to maintain the speed and/or the number of revolutions constant or in the variation interval while the second drive machine is operated in electrical idling, can be acquired as the further performance measure.

The diagnostic condition and/or the further diagnostic condition can only be fulfilled when the steering angle of the motor vehicle lies in a given steering angle interval. In particular, the diagnostic condition and/or the further diagnostic condition can only be fulfilled when basically traveling in a straight line or when the steering angle deviates for example by less than 5° from straight-line travel. Alternatively or additionally, it can be advisable to dictate the reference information in dependence on the detected steering angle. The confinement of the diagnostics to particular steering angle ranges, especially to a straight-line travel, or the dictating of the reference information in dependence on the steering angle, can be advantageous, since the performance required to maintain a particular speed also depends on the steering angle, for example.

In addition or alternatively, it can be advisable for the diagnostic condition and/or the further diagnostic condition to only be fulfilled when a road being driven upon by the motor vehicle has a gradient below a limit value, especially one less than 5° or less than 10°. Alternatively or in addition, the reference information can further depend on the gradient. This is expedient, since the performance for maintaining a given speed also depends on the gradient being traveled upon.

The state information can be a Boolean value, which is determined in dependence on a comparison of the performance measure with the reference information or an intermediate result determined in dependence on the performance measure and the reference information with a given limit value. The state information can be a Boolean value, which is determined in dependence on a comparison of the performance measure with the reference information or an intermediate result determined in dependence on the performance measure and the reference information with a given limit value. In addition or alternatively, the state information can be determined in dependence on the difference or the quotient of the performance measure and the reference information. In particular, this difference or this quotient can be the intermediate result used in the course of the limit value comparison. The Boolean value can indicate in particular whether or not a state of high friction or apparent wear is present.

However, the performance measure can also directly describe the difference or the quotient or it can describe a variation of these quantities over time, which can result in the particular difference or the particular quotient being written into a ring buffer. Thus, for example, by reading out such a ring buffer or by analysis of such a variation in time, it is possible to track the development over time of the state, especially the tribological state, of the drive train. If, as explained above, the further performance measure is additionally acquired, the state information may encompass, for example, also the difference or the quotient formed from the further performance measure and the reference information or further reference information.

If the additional information is a Boolean value and if the further performance measure is acquired, it is possible to make each time a limit value comparison for the performance measure and the further performance measure, i.e., for example, a comparison of the performance measure with the reference information and a comparison of the further performance measure with the reference information or further reference information or a comparison of a respective intermediate results with a respective given limit value, in order to obtain a Boolean partial result each time, after which the state information can be determined as a logical AND operation of the two Boolean partial results. In other words, this state information can only be true when both partial results are true, i.e., for example, when both performance measures show an unusually high performance for maintaining the speed or the number of revolutions.

Optionally, a further state information can also be determined, which for example is only true when a respective limit value is exceeded during a limit value comparison, or generally only when one of the partial results is true. As already explained above, this can warn in particular of a problem in the electrical system of one of the drive machines.

Upon fulfillment of a notice condition dependent on the state information, a notice can be put out to a vehicle passenger and/or to a device formed separate from the motor vehicle. The notice given to the vehicle passenger can be optical, acoustical, or haptic, for example, by a warning light, an indication on a display, a vibration of the steering wheel, or the like.

The device designed separately from the motor vehicle can be for example a mobile communication device, such as a mobile telephone of the vehicle passenger, or a device external to the vehicle, such as a backend server of the vehicle maker or a servicing provider. If the state information is a Boolean value, this can indicate directly whether or not the notice should be put out.

It is also possible to compare the performance measure with various reference information or to compare the intermediate result with various limit values, and a first action on the vehicle side will be triggered upon exceeding a first limit value, for example, and a second action on the vehicle side will be triggered upon exceeding a second limit value. The first action on the vehicle side can be, for example, a relatively low-threshold warning notice, for example the activating of a warning light. The second action on the vehicle side can be for example a more definite warning notice, such as an acoustical notice, or there can also occur a reducing of the maximum available driving performance or the like, for example.

Besides the method according to the disclosure, the disclosure also relates to a motor vehicle having a drive train, which comprises a first drive machine configured as an electric machine and a second drive machine, and a processing device which is adapted to carry out the method according to the disclosure.

In particular, both drive machines are permanently coupled respectively to at least one wheel of the motor vehicle or can be reversibly coupled to it. Features explained about the method according to the disclosure with the benefits mentioned there can be applied to the motor vehicle according to the disclosure and vice versa.

In particular, the motor vehicle can comprise a respective current sensor for detecting the current supplied to the first or second drive machine and a respective voltage sensor for detecting the voltage drop across the first or second drive machine. The drive machines can be separated in particular by electric switches from the current sources or current sinks in the onboard network, in order to make possible an electrical idling of the particular drive machine.

The voltage sensor is not understood as being a current sink on account of its typically very high resistance. Even so, during the electrical idling, the respective current and/or voltage sensor can also be separated optionally from the particular drive machine.

### BRIEF DESCRIPTION OF THE SEVERAL VIEWS OF THE DRAWINGS

Further benefits and details of the disclosure will emerge from the following exemplary embodiments as well as the accompanying drawings.

FIG. 1 schematically shows an exemplary embodiment of a motor vehicle according to the disclosure, and

FIG. 2 schematically shows a flow chart of an exemplary embodiment of the method according to the disclosure.

### DETAILED DESCRIPTION

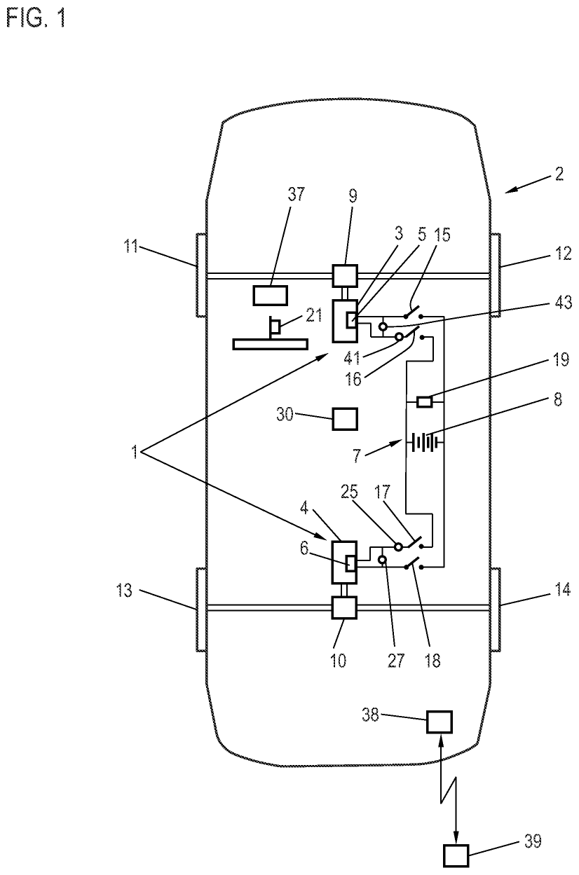

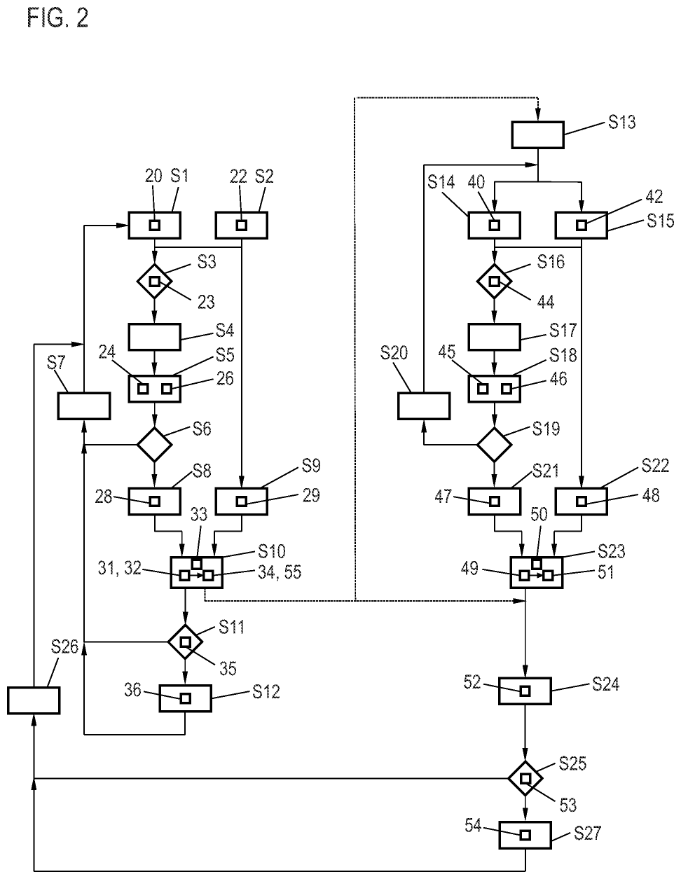

FIG. 1 shows a motor vehicle 2 having a drive train 1, comprising two drive machines 3, 4, each of which is coupled across a differential 9, 10 to two of the wheels 11-14 of the motor vehicle 2. As shall be explained more closely with additional reference to FIG. 2, state information 34, 52 regarding the state of the drive train 1 will be acquired by a processing device 30 of the motor vehicle.. In one or more implementations, the processing device 30 includes a processor and a memory storing instructions that, when executed by the processor, causes the processing device 30 to perform the acts described herein. Specifically, the tribological state is to be acquired in the example, i.e., in particular, increased losses in the drive train 1 from friction occurring due to wear or inadequate lubrication.

Signs as to such a state of the drive train 1 can already be obtained by comparing the performance provided by the drive machines 3, 4 in a particular travel state, for example to maintain a particular speed, with a reference value. For this, the fuel consumption can be detected in the case of internal combustion engines, for example, and the electric power in the case of electric machines.

In electric machines, however, not just a worsening of the tribological state can lead to a reduction of the efficiency, but also defects in the electronics, such as leakage currents, faulty activation of inverters, and the like. Therefore, as shall be explained more precisely in the following with the aid of an exemplary method, the state information 34, 52 regarding the tribological state of the drive train 1 will be determined in the motor vehicle 2, as determined in dependence on a performance measure 28, 47 for at least one of the drive machines 3, 4, while the other respective one of the drive machines 3, 4 continues to be coupled with the respective wheels 11-14 of the motor vehicle, but is operated in an electrical idling mode. Thus, although friction losses are taken into account in both drive machines 3, 4 and in the further components of the drive train, such as the differentials 9, 10 or the wheel bearings of the wheels 11-14, the measurement cannot affect the electrical process of the respective drive machine 3, 4 operated in the electrical idling mode. Especially when only one of the drive machines 3, 4 is an electric machine, or when determinations of a respective performance measure 28, 47 are done for both drive machines 3, 4 while the other respective drive machine 3, 4 is operated in electrical idling mode, influences of the electronics of the drive machines 3, 4 on the determination of the tribological state can be largely ruled out.

FIG. 2 shows a flow chart of an exemplary embodiment of a method for determining a tribological state of the drive train 1 of the motor vehicle 2. The sequence control and computations within the method can be implemented, for example, by the processing device 30 of the motor vehicle 2, but it would also be possible to migrate for example parts of the computations performed to external devices.

In step S1, a steering angle of the motor vehicle 2 is detected at first by a steering angle sensor 21 and in step S2 the number of revolutions of the electric machine 4 is detected. The number of revolutions could be measured directly by a revolution sensor. Typically, however, information as to the number of revolutions of an electric machine is present any way in an associated control device, for example in order to make possible a field-oriented regulation of the electric machine 4, and it can therefore also be retrieved from such a control device.

In step S3, a check is made to see whether a diagnostic condition 23 is fulfilled, the fulfillment of which indicates the presence of a suitable travel state for acquisition of information regarding a tribological state of the drive train 1. One such travel state is in particular a straight-line travel with essentially constant speed. The diagnostic condition 23 can thus be fulfilled in particular when the detected steering angle lies, for a given time interval, within a target interval corresponding to a straight-line travel, and the detected number of revolutions 22 all lie within a variation interval of given breadth, basically corresponding to a constant number of revolutions. In order to monitor the steering angle 20 or the number of revolutions 22 over a time interval, it may be feasible to write the respective measured values in a ring buffer, so that several previous measured values can be considered in the context of the diagnostic condition.

A constant number of revolutions 22 of the drive machine 4 also leads in the example shown in FIG. 1 to a constant speed of the motor vehicle 2, since the drive machine 4 is coupled with a fixed transmission ratio to the differential 10 of the rear axle. If a multi-speed gearbox were to be used, it could be demanded in addition, as a necessary partial condition for fulfillment of the diagnostic condition 23, that no shifting action has been done within the considered time interval. Alternatively or in addition, it would also be possible, for example, to evaluate the vehicle speed instead of the number of revolutions 22, or in addition to the latter.

If the diagnostic condition 23 is not fulfilled, the method is repeated from step S1. But if the diagnostic condition 23 is fulfilled, the processing device 30 in step S4 activates the switches 15, 16, which can be in particular electric switches, i.e., transistors for example, in order to separate the electric machine 3 including its inverter 5 from the onboard network 7 of the motor vehicle and thus from current sources 8, i.e., a battery for example, and current sinks 19, i.e., further consumers for example. The drive machine 3 thus remains coupled across the differential 9 to the wheels 11, 12, so that friction losses in the drive machine 3 continue to slow down the motor vehicle 2, but because of the electrical idling mode the losses in the drive machine 3 are basically independent of the electrical process of the motor vehicle 2 and the drive machine 3.

In step S5, on the one hand the current 24 supplied to the drive machine 4 is then detected by a current sensor 25 and on the other hand the voltage 26 drop across the drive machine 4 is detected by a voltage sensor 27. It is possible here to form the average over a given time interval, for example.

In the example, a direct current and a DC voltage are detected, i.e., voltage and current values prior to the inverter 6 of the drive machine 4. Alternatively, it would also be possible in principle to evaluate alternating voltages and currents for the individual phases of the drive machine 4.

In step S6, it is then checked to see whether the diagnostic condition 23 was fulfilled over the entire time interval for which current and voltage were detected. If this is not the case, then curves were negotiated for example during this time interval or a distinct speed change has occurred, so that the detected measurement values are little suited to determining a tribological state of the drive train 1 and therefore should be rejected. Therefore, in this case the method is repeated from the start, after in step S7 the electric idling of the drive machine 3 was ended by closing the switches 15, 16.

If the diagnostic condition was fulfilled continuously, then in step S8 a performance measure 28 is acquired for the performance produced by the drive machine 4. Since in the example a direct current and a DC voltage are detected, the detected current 24 and the detected voltage 26 or mean values of these quantities can be multiplied directly in order to calculate the performance measure 28. On the other hand, if alternating currents and voltages were detected for individual phases, the individual detected measurement values would have to be multiplied with each other per proper phase, the instantaneous performance per phase so determined would have to be integrated for at least one cycle, and the resulting performances of the individual phases would have to be added up.

In step S9, reference information 29 is dictated, describing in particular an expectation value for the performance measure that would have been reached if the drive train 1 had an optimal condition, i.e., in particular if there were no wear and if the lubrication were good. Since, in order to maintain a speed, different performance is required depending on the speed, this information is dictated in dependence on the detected number of revolutions 22. If a multi-speed gearbox were to be used in the motor vehicle 2, it would be feasible in addition to factor in the gear speed engaged or to detect the speeds directly in step S2.

In the example, in step S10, the difference 32 of the performance measure 28 and the reference information 29 is then calculated at first as an intermediate result 31. This intermediate result 31 thus describes how strongly the currently acquired performance measure 28 deviates from the reference information 29 and it thus constitutes a measure of the additional power loss resulting on account of the current tribological state of the drive train 1.

In principle, this intermediate result 31 could be used directly as state information 34. For example, the intermediate result 31 could be written into a ring buffer, so that by reading out this ring buffer it is possible to read out and evaluate the time development of the state of the drive train 1, for example in the course of a servicing, in order to recognize in good time a need for servicing, a deficient lubrication, or the like. Alternatively to a difference between performance measure 28 and reference information 29, the quotient of these quantities could also be used as such an intermediate result 31.

In the explained exemplary embodiment, however, it is desirable to recognize automatically a presumable state of the drive train 1 in need of servicing, so that in step S10 there is performed in addition a limit value comparison, in which the intermediate result 31 is compared to a given limit value 33, where the state information 34 is a Boolean value which indicates whether this limit value was exceeded.

In an alternative embodiment, it would also be possible to do without the acquisition of the intermediate result 31 and to carry out the limit value comparison for example by comparing the performance measure 28 directly with the reference information 29 as the limit value.

In step S11, a notice condition 35 is then evaluated, which in the example shown is fulfilled at once if the state information 34 indicates an exceeding of the limit value 33 by the intermediate result 31. Optionally, additional conditions can also be taken into account, so that for example the notice condition can only be fulfilled if a corresponding warning function was activated by a user or the like. If the notice condition 35 is not fulfilled, the method is repeated from the start after the ending of the electrical idling mode in step S7.

But if the notice condition 35 is fulfilled, then in step S12 on the one hand a notice 36, such as a warning symbol, is put out to a vehicle passenger by a notice device 37, such as a display. In addition, through a communication device 38 of the motor vehicle a message is put out to a device 39 designed separate from the motor vehicle 2, such as a backend server of the vehicle maker, in order to also register there a presumably required servicing.

While thanks to the use of the electrical idling mode of the first drive machine 3 in the method explained above in relation to steps S1 to S12 an influencing of the electrical process of this drive machine 3 on the determination of the tribological state of the drive train 1 was substantially precluded, it is furthermore possible in the explained method that electrical properties of the drive machine 4, such as a poor electrical efficiency, could lead to a faulty recognition of a problematical tribological state of the drive train 1. This risk can be significantly reduced when steps S11 and S12 are replaced by the optional steps S13 to S27.

The result of the limit value comparison in step S10 does not as yet constitute the state information 34 in this case, but only a partial result 55. With these additional steps S13 to S27, a similar acquisition of a performance measure is implemented, such as was already explained, but in these steps upon fulfillment of the diagnostic condition 44 used there the second drive machine 4 instead of the first drive machine 3 is separated from the onboard network 7 and the acquisition of the performance measure is done for the drive machine 3. As was already explained in detail in the general section, in this way a much better distinction can be drawn between efficiency losses of the electrical process and efficiency losses due to the tribological state of the drive train 1. Due to the great similarity with the previously explained method, the additional steps will only be explained briefly in the following.

In step S13, the switches 15, 16 are closed, in order to end the electrical idling mode of the drive machine 3.

Next, in step S14, corresponding to step S1, a steering angle 40 is detected and in step S15, corresponding to step S2, a number of revolutions 42 is detected, this involving preferably the number of revolutions 42 of the first drive machine 3.

In step S16, the diagnostic condition 44 is evaluated, preferably being exactly fulfilled, as already explained for step S3 and the diagnostic condition 23 used there, if the detected steering angle 40 and number of revolutions 42 indicate a straight-line travel with substantially constant speed.

If the diagnostic condition 44 is not fulfilled, the method is repeated from step S14. But if the diagnostic condition 44 is fulfilled, then the switches 17, 18 are opened in step S17, in order to achieve an electrical idling mode of the drive machine 4.

During this electrical idling mode, in step S18, the current 45 supplied to the drive machine 3 is determined by the current sensor 41 and the voltage drop 46 across the drive machine 3 is determined by the voltage sensor 43.

In step S19, corresponding to step S6, a check is made to see whether the diagnostic condition 44 was fulfilled throughout the measurement interval. If this is not the case, then in step S20 the electrical idling mode of the drive machine 4 is ended by closing the switches 17, 18. But if the diagnostic condition 44 was fulfilled, then in step S21 the performance measure 47 for the drive machine 3 is calculated, in particular by multiplying the current 45 and voltage 46.

In step S22, the reference value 48 is determined in dependence on the number of revolutions 42 or the speed of the motor vehicle, as was already explained in regard to step S9 and the reference value 29.

In step S23, similar to what was explained for step S10, the intermediate result 49 is determined in dependence on the performance measure 47 and the reference value 48, especially as the difference between these values, and this is compared with the limit value 50, in order to determine a further partial result 51, which in turn indicates as a Boolean quantity whether the limit value 50 has been exceeded.

In step S24, the partial results 51, 55 for the state information 52 are combined. In particular, the state information 52 can correspond to a logical AND operation of the partial results 51, 55, so that the state information 52 is only true if both the limit value 33 in step S10 and the limit value 50 in step S23 was exceeded. This is expedient, since an increasing of the performance measure on account of a defective or at least suboptimal functioning power electronics of one of the drive machines 3, 4 can only result if the respective drive machine 3, 4 is not being operated in electrical idling mode. But since the first drive machine 3 is operated in electrical idling mode to determine the partial result 55 and the second drive machine 4 is operated in electrical idling mode to determine the partial result 51, a suboptimal power electronics can only lead through the logical AND operation in step S24 to the finding of a defective tribological state of the drive train 1 if the increase in the performance measure is in fact at least partly due to high friction in the drive train 1 or if the power electronics are so faulty that the operation of both drive machines 3, 4 is affected, although this is much less likely than a suboptimal function of the power electronics of one of the drive machines 3, 4.

Steps S25 and S27 correspond basically to steps S22 and S12, that is, in step S25 the notice condition 53 is evaluated, which can then be fulfilled in particular if the state information 52 is true, and in step S27 a warning 54 is put out, which can essentially correspond to the warning 36.

If the notice condition 53 is not fulfilled in step 25 or after step S27, the method is repeated from the start, the electric idling of the drive machine 4 being ended first in step S26 by closing the switches 17, 18.

As an additional step, for example when exactly one of the partial results 51, 55 is true, a different notice could be given to the vehicle passenger or the device 39, in order to notify him or it that there is apparently present a defect or at least a suboptimal functioning of the power electronics of the motor vehicle 2.

German patent application no. 102022117410.7, filed Jul. 13, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for determination of state information that describes a state of a drive train including a first drive machine and a second drive machine of a motor vehicle, the first drive machine including a first electric machine, the method comprising:
upon fulfillment of a first diagnostic condition, operating the first drive machine in an electrical idling mode in which the first drive machine is electrically separated from current sources and current sinks and coupled to at least one first wheel of the motor vehicle, and
during the operating of the first drive machine in the electrical idling mode, acquiring a first performance measure of the second drive machine, while at least one second wheel of the motor vehicle is driven by the second drive machine; and
determining the state information based on the first performance measure and given reference information.

2. The method according to claim 1,
wherein the state information describes a tribological state of the drive train.

3. The method according to claim 1,
wherein the second drive machine includes a second electric machine,
wherein the method further comprises:
detecting a current supplied to the second drive machine, using a current sensor of the motor vehicle; and
detecting a voltage dropping across the second drive machine, using a voltage sensor of the motor vehicle, and
wherein the first performance measure is acquired as a product of the current and the voltage or is based on the product of the current and voltage.

4. The method according to claim 3,
wherein the current is a direct current (DC) current and the voltage is a DC voltage.

5. The method according to claim 1,
wherein the second drive machine includes a second electric machine,
wherein the method further comprises:
after acquiring the first performance measure, determining that the first diagnostic condition or a second diagnostic condition is fulfilled;
operating the second drive machine in an electrical idling mode in which the second drive machine is electrically separated from current sources and current sinks and coupled to at least one second wheel of the motor vehicle; and
during the operating of the second drive machine in the electrical idling mode, acquiring a second performance measure of the first drive machine, while the at least one first wheel of the motor vehicle is driven by the first drive machine; and
determining the state information based on the first performance measure and the second performance measure.

6. The method according to claim 1,
wherein the given reference information is based on a speed of the motor vehicle or a number of revolutions of the first drive machine or the second drive machine.

7. The method according to claim 1,
wherein the first diagnostic condition is fulfilled when a speed of the motor vehicle or a number of revolutions of the first drive machine or the second drive machine is constant across a given time interval or lies within a range of variation with given breadth, and
wherein a measure of performance of the second drive machine that is applied in order to maintain the speed or the number of revolutions constant or in a variation interval while the first drive machine is operated in electrical idling mode, is acquired as the first performance measure.

8. The method according to claim 5,
wherein the first diagnostic condition or the second diagnostic condition is fulfilled when a steering angle of the motor vehicle lies in a given steering angle interval.

9. The method according to claim 5,
wherein the first diagnostic condition or the second diagnostic condition is fulfilled when a road being driven upon by the motor vehicle has a gradient below a limit value.

10. The method according to claim 9,
wherein the limit value is 5° or 10°.

11. The method according to claim 1,
wherein the state information is a Boolean value that is determined based on a comparison of the first performance measure with the give reference information or an intermediate result determined based on the first performance measure and the given reference information with a given limit value, or the state information is determined based on a difference or a quotient of the first performance measure and the given reference information.

12. The method according to claim 1, further comprising:
upon fulfillment of a notice condition based on the state information, outputting a notice to a vehicle passenger or a device separate from the motor vehicle.

13. A motor vehicle comprising:
a drive train including a first drive machine and a second drive machine, wherein the first drive machine includes an electric machine; and
a processing device,
wherein the processing device, in operation,
upon fulfillment of a diagnostic condition, operates the first drive machine in an electrical idling mode in which the first drive machine is electrically separated from current sources and current sinks and coupled to at least one first wheel of the motor vehicle;
during operation of the first drive machine in the electrical idling mode, acquires a performance measure of the second drive machine, while at least one second wheel of the motor vehicle is driven by the second drive machine; and
determines state information describing a state of the drive train based on the performance measure and given reference information.
